(19) United States
(12) Patent Application Publication
(10) Pub. No.: US 2008/0307093 A1
(43) Pub. Date: Dec. 11, 2008

(54) Method and system for managing resource consumption by transport control protocol connections

(75) Inventors: Yu Song, Pleasanton, CA (US); Doreen Cheng, San Jose, CA (US); Alan Messer, Los Gatos, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/811,178

(22) Filed: Jun. 7, 2007

(51) Int. Cl. G06F 15/173

(52) U.S. Cl. 709/226

(57) ABSTRACT

A method and system for managing resource consumption by TCP connections. After establishing a TCP connection between two devices, such as a client and a server, the TCP connection is placed into a dormant mode when the server has no data to send to the client. Only when there is data to be sent, is the TCP connection awakened and the required resources for communication allocated for the TCP connection. This approach reduces resource usage for a TCP connection, and enables a TCP server to push information to a large number of clients.

### FIELD OF THE INVENTION

The present invention relates to managing data transport connections and in particular, to managing Transport Control Protocol (TCP) connections.

### BACKGROUND OF THE INVENTION

A fundamental tenet of information retrieval on the Internet/Web is a request-reply paradigm. In this paradigm, a Web client (e.g., a browser) makes a request to a Web server and receives a response. This paradigm scales well for a Web server that can serve a large number of clients. However, a Web client cannot obtain updated information from a Web server until the client asks for it (e.g., the client sends a request to obtain updated information). If the client needs to know the information in a timely manner, the client must frequently poll the server for the information, which unnecessarily increases the network traffic.

A better way of obtaining updated information from a Web server is for the Web server to proactively push updates to the client. One approach for pushing updates to a client is for the client to open a TCP connection in passive mode such that a Web server can establish a connection to the Web client whenever the server has something to send. However, since most clients are behind firewalls that only allow out-bound traffic while denying in-bound traffic, such firewalls prevent a TCP connection initiated from the server.

To overcome this problem, one solution is to change the firewall configuration such that whenever there is incoming traffic designated to a specific port, the firewall allows the traffic to go through. This solution, however, is not favorable because of the potential security hole of opening a port on the firewall. Another problem is posed by a common network address translation (NAT) process. Many networks, especially networks in homes, are private networks. Devices in such networks have private address that cannot be directly reached. To reach such devices, a public IP address must be translated to a private IP address by the NAT. To allow a Web client to receive updates from a Web server, the NAT must be configured with port forwarding such that when a packet is received by the NAT, it forwards it to the Web client. For every Web client that wishes to obtain updates, an entry in the NAT static translation table must be created. This does not scale well because the number of entries in such a table is limited for a private network, and when there is a large number of Web clients that need updates there might not be sufficient entries in the table for each Web client.

The Real Simple Syndication (RSS) is a Web feed that allows a Web client to periodically poll a Web server to obtain updated information, such as news headlines. The RSS XML file specifies how often the server can be pulled. This approach is widely accepted as a way of obtaining updates on the Internet because of its simplicity. However, it is still based on a request-response approach wherein updates cannot make their way from the server to a client until the next scheduled pull.

Another approach to obtaining updates is to use a HTTP multipart header, wherein a Web client makes a request to a Web server via a connection and then maintains that open connection. The Web server sends a response to the client indicating the response is a multiple sequence of responses, and each response is an update. The drawbacks of such a method are scalability and requiring an active open connection between the Web server and the client for a lengthy time period. This wastes server resources especially when there are a large number of concurrent connections on a server since the server must keep information about every connection, including a buffer (e.g., 32 kilobytes) for input/output packets. There is therefore a need for a method of reducing TCP connection resource consumption.

### BRIEF SUMMARY OF THE INVENTION

The present invention provides a method and system for managing resource consumption by TCP connections. In one embodiment, after establishing a TCP connection between two devices, such as a client and a server, the TCP connection is placed into a sleep mode (i.e., dormant mode) when the server has no data to send to the client. As such, after a TCP connection between the two devices has been established, when a device has no data to send to the other device, the TCP connection is placed into a sleep mode, wherein the required resources for communication over the TCP connection are released (deallocated). Only when there is data to be sent, is the TCP connection awakened (placed in normal mode) and the required resources for communication allocated (or reallocated) for the TCP connection. This approach reduces resource usage for a TCP connection, and enables a TCP server to push information to a large number of clients.

These and other features, aspects and advantages of the present invention will become understood with reference to the following description, appended claims and accompanying figures.

### BRIEF DESCRIPTION OF THE DRAWINGS

FIG. 1 shows a functional block diagram of a system wherein two devices establishing and managing a TCP connection therebetween, according to an embodiment of the present invention.

FIG. 2 shows a flowchart of an example process for establishing and managing a TCP connection between the devices in FIG. 1, according to the present invention.

FIG. 3 shows a functional block diagram of plural client devices and a server establishing and managing plural TCP connections therebetween, according to another embodiment of the present invention.

FIG. 4 shows plural concurrent TCP connections between the plural clients and the server in FIG. 3.

### DETAILED DESCRIPTION OF THE INVENTION

According to the RFC 973 specification (September 1981), TCP is intended for reliable host-to-host protocol between hosts in packet-switched computer communication networks, and in interconnected systems of such networks. TCP is a connection-oriented, end-to-end protocol designed to fit into a layered hierarchy of protocols which support multi-network applications. TCP provides a connection-oriented protocol, wherein a connection is established between two devices (i.e., endpoints, nodes or peers, etc.). TCP fits into a layered protocol architecture just above a basic Internet Protocol which provides a way for the TCP to send and receive variable-length segments of information enclosed in internet datagram “envelopes”. The internet datagram provides a means for addressing source and destination TCPs in different networks.

The present invention provides a method and system for managing resource consumption by TCP connections. In one embodiment, managing resource consumption involves reducing resources used by TCP connections between plural clients and a server, thereby enabling a large number of concurrent connections to the server while conserving resources. The server pushes data to a large number of concurrent clients. The server can further push data to a client behind a firewall and/or a NAT.

Typically, a TCP connection is identified by two peers at the endpoints of the connection (a TCP connection is established between a pair of nodes). From a node point of view, its remote peer is a node that it established a TCP connection with.

Typically, TCP connection resources are represented by the following states which are maintained for the TCP connection: a TCP connection sequence number, a TCP acknowledgement number, a TCP data buffer, a TCP sliding window starting and ending indices in the buffer, a local port number, an IP address for the port number of a remote peer, and an old round trip time (RTT) and an expected current RTT or a new RTT.

Of the above states, the buffer consumes the majority of system/network resources such as memory. In order to manage resource consumption, according to the present invention, the buffer is allocated when there is data to send over the TCP connection, and then the buffer is released when there is no data to send over the TCP connection. A TCP connection is established between a pair of endpoints, a first endpoint and a second endpoint (i.e., peer endpoints or peer nodes). Then, the first endpoint informs the second endpoint that the second endpoint only needs to allocate resources when there is data to be sent to the first endpoint. Any one of the two endpoints can inform the other endpoint to release (deallocate) the connection resource.

Further according to the present invention three TCP connection modes are provided: (1) normal mode, (2) sleep (dormant) mode, and (3) wait mode. A TCP connection endpoint (node) can be in one of three modes. In the normal mode, each endpoint behaves in the manner specified in the conventional TCP standard. During the sleep mode, an endpoint releases it TCP memory buffer. An endpoint enters the sleep mode when it receives a “SLEEP” packet/message from its remote peer endpoint. As such, after a TCP connection between the endpoints has been established, when an endpoint has no data to send to the other endpoint, the TCP connection is placed into a sleep mode (i.e., a dormant mode) wherein the required resources for communication over the TCP connection are released (deallocated). Only when there is data to be sent, is the TCP connection awakened (placed in normal mode), and the required resources for communication over the TCP connection are allocated (or reallocated).

Before entering the sleep mode, an endpoint first releases (deallocates) the communication resources (e.g., buffer) allocated for the TCP connection. If one endpoint is in the sleep mode (sleeping peer) then the other endpoint is in the wait mode (waiting peer). When there is data to be sent to the waiting peer, the sleeping peer wakes up and allocates communication resources (e.g., buffer) needed for the data. The waiting peer must keep the communication resources (e.g., buffer) available for receiving the data (i.e., the waiting peer does not release the buffer allocated by/for the sleeping peer).

In the wait mode, an endpoint (i.e., node or peer) does not send any TCP data, but instead, waits for incoming packets. For example, an endpoint enters the wait mode when instructed by an application (e.g., in Unix, a sockopt system call with WAIT as its parameter). If a waiting peer/endpoint has data to send over the TCP connection to its peer who is in sleep mode (sleeping peer), then the waiting peer must first wake up the sleeping peer. Then, the waiting peer must wait for acknowledgement from the sleeping peer that it is awakened and is in the normal mode before the waiting peer sends any data to its peer over the TCP connection.

In one example, a first endpoint of a TCP connection can enter sleep mode only when it is certain that its peer endpoint will not send any data over the TCP connection unless the first endpoint sends data first. This property fits the request-response paradigm, wherein sending updates from a server to a client follows the request-response paradigm. The server endpoint in the TCP connection can enter sleep mode as it is certain that the client endpoint will not send any data over the TCP connection unless the server endpoint sends updates first. The server sends updates and the client sends replies in response to the updates.

Therefore, a client can initiate a TCP connection and inform the server that the client is waiting for updates (i.e., the client will not send any data before receiving updates from the server). When the server knows that the client is waiting for updates, the server can place the TCP connection into sleep mode, and release connection resources, such as the buffer, associated with the TCP connection. The server wakes up the connection, only when the server has data to send to the client over the TCP connection, and reallocates the required TCP connection resources such as a data buffer.

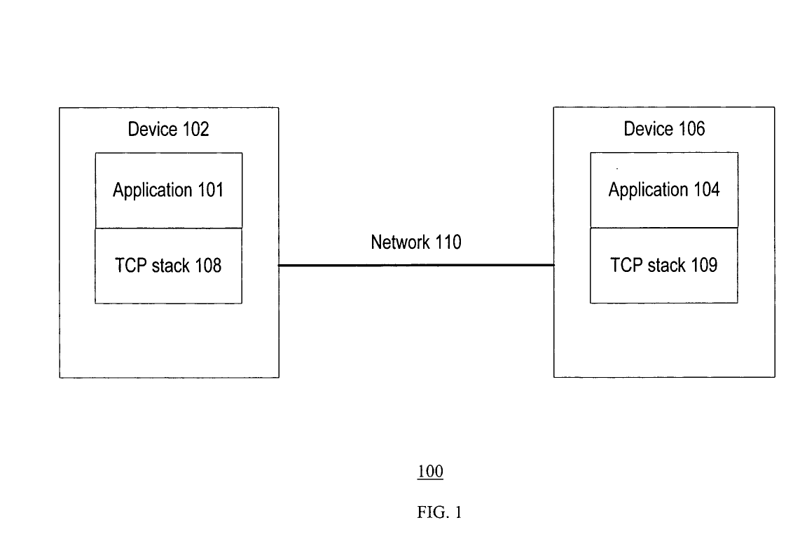

FIG. 1 shows a functional block diagram of a system 100 including a device 102 (e.g., a Web client) and a device 106 (e.g., Web server) establishing and managing a TCP connection therebetween, according to an embodiment of the present invention. The devices 102 and 106 form the two endpoints of a TCP connection as peers.

An application 101 is implemented on the device 102, and an application 104 is implemented on the device 106. The application 101 uses a TCP client (e.g., Unix socket) to communicate with another application that uses a TCP server (e.g., Unix server socket). For example, the application 101 can be a browser that opens TCP client sockets to a Web server that listens on a server socket. The application 104 uses a TCP server (e.g., Unix server socket) to communicate with applications use TCP clients. An example of application 104 is a Web server. The devices 102 and 106 are connected via the network 110 through which a TCP connection can be established. The device 102 includes a TCP stack 108 and the device 106 includes a TCP stack 109. The TCP stacks are used by the applications 101 and the application 104 for communication via a TCP connection over the network 110. Examples of network 110 includes IP networks, such as Internet, LAN, etc. A TCP stack is a software module that implements the TCP specification (RFC 793).

The application 101 and the TCP stack 108 form a resource management module configured for managing a TCP connection, including resource management, according to steps described herein according to the present invention. Further, the application 104 and the TCP stack 109 form a management module configured for managing a TCP connection, including resource management, according to steps described herein according to the present invention.

In each node (device), the TCP stack is a resource management module that manages the connection between two peer nodes, ensuring the ordering of incoming packets, and managing the throughput of the connection, etc. The corresponding application in that node uses the TCP stack for communication purposes.

The applications instruct their corresponding TCP stacks to establish a connection (e.g., socket APIs in Unix). Upon receiving the instructions, the TCP stacks on the peers establish the connection between them. The applications then instruct the TCP stacks to transition (e.g., using socket APIs) a TCP connection from one TCP connection mode to another TCP connection mode. Upon receiving the instruction, each TCP stack transitions the connection from one mode to another mode with release/re-allocate resources. When an application instructs its corresponding TCP stack to transition the connection to sleep mode, the TCP stack releases resources for the connection, and actively sends a message to its peer TCP stack about the TCP connection status.

In a node, an application need not instruct its corresponding TCP stack to transition the TCP connection to the normal mode. When an application has data to send, the application sends the data using existing API (e.g., write API) for a TCP connection. Upon receiving the data from the application, if the connection is in sleep mode, the corresponding TCP stack re-allocates resources for this connection, wherein the connection transitions from sleep mode to normal mode for transmitting the data to a peer.

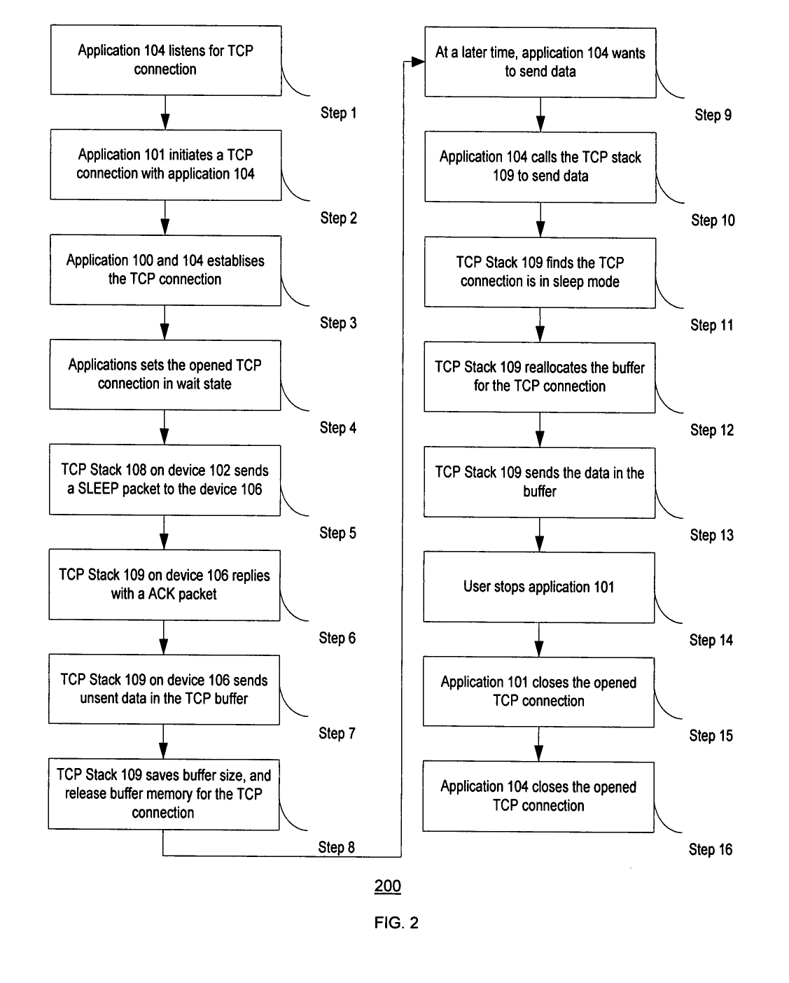

FIG. 2 shows a flowchart of an example process 200 for managing a TCP connection between the devices 102 and 106 in FIG. 1, according to the present invention. The process 200 includes the following steps:
1. The application 104 opens a port for TCP connections on the network 110 and listens for connection requests.
2. The application 101 initiates a TCP connection to the application 104 by requesting a connection to the TCP port opened in step 1.
3. The application 104 receives the request and a TCP connection is established between the application 101 and the application 104, including an allocation of memory for a buffer on both TCP stacks 108 and 109.
4. The application 104 on the device 106 sets its TCP connection to wait mode.
5. The TCP stack 108 on the device 102 sends a SLEEP packet to the device 106. The SLEEP packet comprises a TCP acknowledge (ACK) packet with a SLEEP option in the TCP option header. This indicates that the application 101 will not send any messages on the TCP connection, and instead waits for messages from the application 104.
6. The TCP stack 109 on the device 106 receives the SLEEP packet, and increases an acknowledgement number by 1. The TCP stack 109 then sends an ACK packet back to the device 102. An acknowledge is a particular TCP packet to inform a remote peer that it (this TCP peer) has received data. Each TCP packet is numbered to eliminate duplication and in case a packet is missing, re-sending the packet.
7. After sending the ACK packet, the TCP stack 109 further checks the buffer for the TCP connection. If there is any unsent data in the buffer, the TCP stack 109 sends them to the application 101 over the TCP connection.
8. After sending the unsent data, the TCP stack 109 saves the buffer size of the TCP connection, and releases the memory of the buffer.
9. At a later time, the application 104 desires to send data to the application 101 over the TCP connection.
10. The application 104 issues a system call to the TCP stack 109 on the device 106 to send the data to the application 101 over the TCP connection.
11. The TCP stack 109 determines that the TCP connection for sending the data is in sleep mode. In one implementation, there can be a mode status variable in the TCP stack that indicates which mode the TCP is in.
12. The TCP stack 109 uses the saved buffer size to reallocate memory for a buffer for the TCP connection.
13. The TCP stack 109 then copies the data to the reallocated buffer, and sends the data to the application 101 over the TCP connection. Though the TCP connection is in sleep mode, data can be sent over the TCP in the sleep mode by reallocating the memory buffer of the TCP connection
14. At a later time, the user of the device 102 stops the execution of the application 101.
15. Before exiting, the application 101 closes the opened TCP connection.
16. This causes the TCP connection to be closed in the application 104 as well, including releasing the memory for the reallocated buffer.

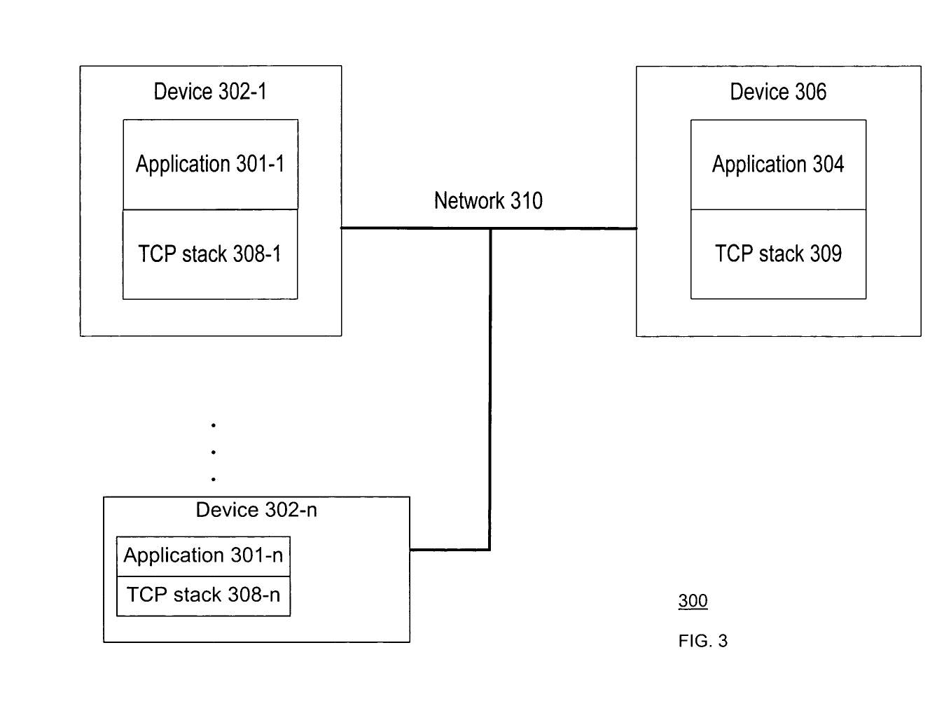

FIG. 3 shows a functional block diagram of a device 306 (e.g., a Web server) and plural devices 302-1, . . . , 302-n (e.g., n Web clients), establishing plural TCP connections therebetween (n>1), according to another embodiment of the present invention. The devices 302-1, . . . , 302-n include applications 301-1, . . . , 301-n, respectively, similar to the application 101 in FIG. 1. Further, the device 306 includes an application 304, similar to the application 104 in FIG. 1. The devices 302-1, . . . , 302-n further include TCP stacks 308-1, . . . , 308-n, respectively, similar to the TCP stack 108 in FIG. 1. Further, the device 406 includes a TCP stack 309, similar to the TCP stack 109 in FIG. 1.

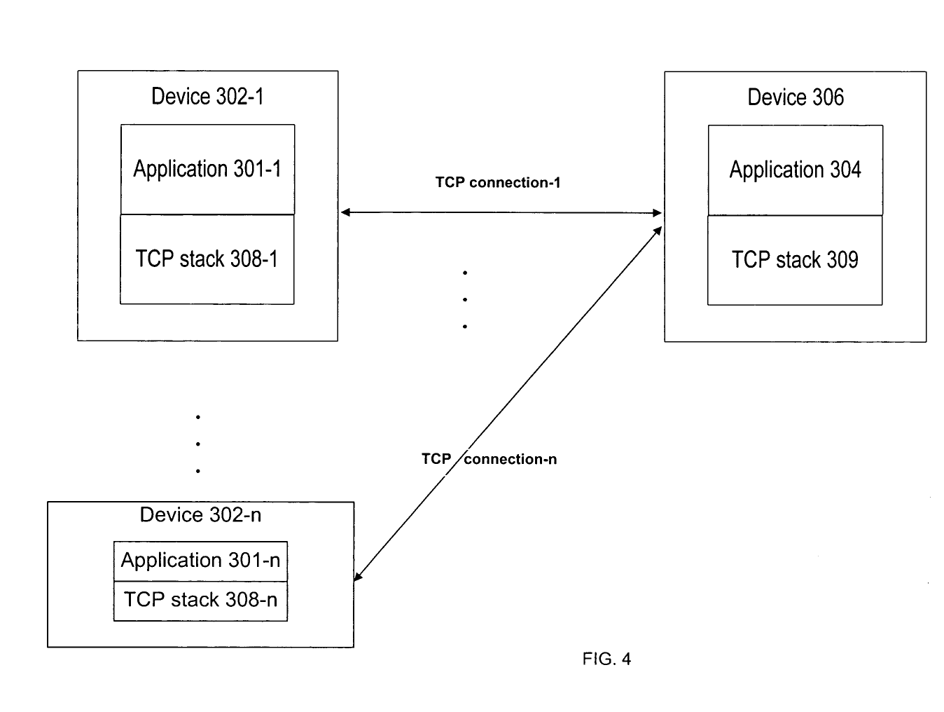

The TCP stacks are used by the application 304 and the applications 301-1, . . . , 301-n, for communication via the TCP connections over the network 310. Each of the devices 302-1, . . . , 302-n can establish its own TCP connection with the device 306 (FIG. 4), such that there can be two or more concurrent TCP connections (TCP connection-1, . . . , TCP connection-n) between the devices 302-1, . . . , 302-n and the device 306 (FIG. 4). Each of the devices 302-1, . . . , 302-n communicates with the device 306 over a TCP connection essentially using the process 200 in FIG. 2. Each pairing of the device 306 with each of the devices 302-1, . . . , 302-n, forms the two endpoints of a TCP connection as peers. Where the device 306 functions as a server and the plural devices 302-1, . . . , 302-n function as clients, the server 306 pushes data to the plural concurrent clients 302-1, . . . , 302-n.

Further, the plural TCP connections to the device 106 can be over different networks. For example, a subset of the devices 302-1, . . . , 302-n can establish TCP connections to the device 306 over one communication link (e.g., the Internet), while another subset of the devices 302-1, . . . , 302-n can establish TCP connections to the device 306 over another communication link (e.g., a wireless cellular network).

By reducing the resources (e.g., buffer) used by TCP connections between plural (n) clients and a server, the present invention enables a large number of concurrent connections to the server while conserving resources. The server pushes data to a large number of concurrent clients. The server can further push data to a client behind a firewall and/or a NAT.

Since a TCP connection is a duplex connection wherein peers at both ends of the connection can both send and receive packets, the present invention further enables one peer to inform the other peer to sleep in both directions, i.e., both peers can inform the other peer to sleep. When one peer has data to send to the other, it first sends a WAKE packet to the sleeping peer, and then waits for an ACK from the sleeping peer before sending the data. When a peer receives a WAKE packet, it wakes up, reallocates the buffer, and sends an ACK packet back to the sending peer. Only after receiving the ACK packet can the sending peer start sending.

In the description hereinabove, connections between a Web server and a Web client are used as example applications of the present invention. In general, however, as those skilled in the art will recognize, the present invention is useful for managing all TCP connections.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method of managing resource consumption by Transport Control Protocol (TCP) connections, comprising the steps of:
establishing a TCP connection between two peer devices over a communication link;
managing communication resources by:
placing the TCP connection into a dormant mode when a peer device has no data to send to the other peer device; and
placing the TCP connection into a normal mode and allocating resources for communication over the TCP connection when a peer device has data to send to the other peer device.

2. The method of claim 1 wherein placing the TCP connection into a dormant mode includes deallocating resources for communication over the TCP connection.

3. The method of claim 2 wherein placing the TCP connection into a dormant mode further includes the step of placing the TCP connection into the dormant mode only when a first peer device is certain that the other peer device will not send any data over the TCP connection unless the first peer device sends data over the TCP connection first.

4. The method of claim 1 wherein the first peer device comprises a server and the second peer device comprises a client.

5. The method of claim 4 wherein sending data from the server to the client follows a request-response paradigm wherein the client only responds to the server only when the server sends data to the client first, such that the step of placing the TCP connection into a dormant mode further includes the server placing the TCP connection into a dormant mode as the client sends data to the server over the TCP connection only when the server sends data to the client over the TCP connection first.

6. The method of claim 4 wherein the first peer device comprises a Web server and the second peer device comprises a Web client.

7. The method of claim 1 further comprising the step of:
a first peer device informing a second peer device to allocate resources for communication over the TCP connection only when the second peer device has data to send to the first peer device over the TCP connection.

8. The method of claim 1 further comprising the step of:
a first peer device informing a second peer device to deallocate communication resources for the TCP connection.

9. The method of claim 1 wherein allocating resources for communication over the TCP connection includes allocating a memory buffer for data.

10. The method of claim 9 wherein the step of managing communication resources further includes allocating the buffer when there is data to send over the TCP connection, and deallocating the buffer when there is no data to send over the TCP connection.

11. The method of claim 1 further comprising the steps of:
a first peer device informing a second peer device to allocate communication resources;
the first peer device receiving an acknowledgement from the second peer device; and
upon receiving an acknowledgement from the second peer device, the first peer device sending data to the second peer device over the TCP connection.

12. A method of managing resource consumption by Transport Control Protocol (TCP) connections, comprising the steps of:
establishing plural TCP connections between a first peer device and plural second peer devices over one or more communication links, wherein each TCP connection has the first peer device at one end and one of the second peer devices at the other end; and
managing communication resources for each TCP connection by:
placing the TCP connection into a dormant mode when a peer device of that TCP connection has no data to send to the other peer device of that TCP connection; and
placing the TCP connection into a normal mode and allocating resources for communication over the TCP connection, when a peer device of that TCP connection has data to send to the other peer device of that TCP connection.

13. The method of claim 12 wherein the first peer device pushes data to the second peer devices over the TCP connections.

14. The method of claim 12 wherein placing a TCP connection into a dormant mode further includes deallocating resources for communication over the TCP connection.

15. The method of claim 14 wherein placing a TCP connection into a dormant mode further includes the step of the first peer device of the TCP connection placing the TCP connection into the dormant mode when that first peer device has no data to send to the second peer device of the TCP connection.

16. The method of claim 14 wherein the first peer device comprises a server and each second peer device comprises a client such that the server pushes data to each client over a corresponding TCP connection.

17. An apparatus for managing resource consumption by Transport Control Protocol (TCP) connections, comprising:
a TCP stack configured for establishing a TCP connection between two peer devices over a communication link;
an application module configured for instructing the TCP stack to place the TCP connection into a dormant mode when a peer device has no data to send to the other peer device, and to place the TCP connection into a normal mode and allocate resources for communication over the TCP connection when a peer device has data to send to the other peer device.

18. The apparatus of claim 17 wherein the application module is configured for instructing the TCP stack to place the TCP connection into a dormant mode further by deallocating resources for communication over the TCP connection.

19. The apparatus of claim 18 wherein the application module is further configured for instructing the TCP stack to place the TCP connection into a dormant mode only when a first peer device is certain that the other peer device will not send any data over the TCP connection unless the first peer device sends data over the TCP connection first.

20. The apparatus of claim 17 wherein the first peer device comprises a server and the second peer device comprises a client.

21. The apparatus of claim 20 wherein sending data from the server to a client follows a request-response paradigm wherein the client responds to the server only when the server sends data to the client first, such that placing the TCP connection into a dormant mode further includes the server placing the TCP connection into a dormant mode because the client sends data to the server over the TCP connection only when the server sends data to the client over the TCP connection first.

22. A system for managing resource consumption by Transport Control Protocol (TCP) connections between a pair of peer devices, comprising:
a first management module including a first TCP stack; and
a second management module including a second TCP stack;
wherein the TCP stacks are configured for establishing a TCP connection between two peer devices over a communication link; and
the first management module further including a first application module configured for instructing the first TCP stack to place the TCP connection into a dormant mode when a peer device has no data to send to the other peer device, and to place the TCP connection into a normal mode and allocate resources for communication over the TCP connection when a peer device has data to send to the other peer device.

23. The system of claim 22 wherein the second management module further including a second application module configured for instructing the second TCP stack to place the TCP connection into a dormant mode when a peer device has no data to send to the other peer device, and to place the TCP connection into a normal mode and allocate resources for communication over the TCP connection when a peer device has data to send to the other peer device.

24. The system of claim 23 wherein the first management module informs the second management module to allocate resources for communication over the TCP connection only when the second peer device has data to send to the first peer device over the TCP connection.

25. The system of claim 23 wherein the first management module informs the second management module to deallocate communication resources for the TCP connection.

26. The system of claim 23 wherein allocating resources for communication over the TCP connection includes allocating a memory buffer for data.

27. The system of claim 26 wherein the buffer is allocated when there is data to send over the TCP connection, and deallocated when there is no data to send over the TCP connection.

28. The system of claim 23 wherein:
the first management module informs the second management module to allocate TCP connection communication resources;
the first management module receives an acknowledgement from the second management module; and
upon receiving an acknowledgement from the second management module, the first peer device sends data to the second peer device over the TCP connection.
